(19) United States
(12) Patent Application Publication
(10) Pub. No.: US 2024/0153702 A1
(43) Pub. Date: May 9, 2024

(54) Electronic Component Having Improved Heat Resistance

(71) Applicant: KEMET Electronics Corporation, Fort Lauderdale, FL (US)

(72) Inventors: Marco Michelazzi, Sasso Marconi (IT); Vincenzo Emanuele Caridà, Sasso Marconi (IT); Federico Fantini, Sasso Marconi (IT); Evangelista Boni, Sasso Marconi (IT); Walter Bruno, Sasso Marconi (IT)

(21) Appl. No.: 18/413,844

(22) Filed: Jan. 16, 2024

Related U.S. Application Data
(63) Continuation-in-part of application No. 17/709,634, filed on Mar. 31, 2022.
(60) Provisional application No. 63/168,490, filed on Mar. 31, 2021.

(51) Int. Cl. H01G 2/08; H01G 4/14; H01G 4/224; H01G 4/33

(52) U.S. Cl. CPC H01G 2/08; H01G 4/14; H01G 4/224; H01G 4/33

(57) ABSTRACT

Provided is an electronic component, and particularly a film capacitor, comprising a working element comprising a dielectric and an encasement with the working element encased in said encasement wherein the encasement comprises a phase change material.

### FIELD OF THE INVENTION

This application is a Continuation-in-Part application of pending U.S. patent application Ser. No. 17/709,634 filed Mar. 31, 2022 which, in turn, claims priority to expired U.S. Provisional Application No. 63/168,490 filed Mar. 31, 2021 both of which are incorporated herein by reference.

### FIELD OF THE INVENTION

The invention is related to improved electronic components, and particularly film capacitors, which are thermally stable due to the inclusion of a phase change material (PCM) as a heat absorber.

### BACKGROUND

Film capacitors, particularly polypropylene based film capacitors, have found great favor in many applications due to their electrical and physical attributes. One property of film capacitors which has limited their use is thermal instability due to degradation of the film, particularly polypropylene film, within the capacitor at elevated temperatures. The film capacitor may be exposed to detrimental heat when being mounted to a circuit board or during normal use. In either case, potential for exposure to high temperature renders film capacitors unsuitable in many otherwise advantageous uses.

There has been an ongoing desire for an electronic component, and particularly a film capacitor, which is capable of exposure to high temperatures wherein the electronic component maintains its performance characteristics. Provided herein is an improved electronic component, and specifically a film capacitor, which is capable of temperature excursions without detriment.

### SUMMARY OF THE INVENTION

The present invention is related to an improved electronic component, and particularly a film capacitor, which is capable of high temperature exposure without physical or electrical degradation.

More specifically, the present invention is related to an improved film capacitor comprising a phase change material, external to the working element and preferably in the encasement, wherein upon exposure to high temperature excursions the phase change material absorbs the heat prior to the working element being heated.

A particular advantage of the invention is the ability to use conventional working elements and manufacturing processes without alteration.

Another particular advantage is that the phase change material does not interfere with the electrical characteristics of the working element or the ability to function as intended.

These and other advantages, as will be realized, are provided in an electronic component, and particularly a film capacitor, comprising a working element comprising a dielectric and an encasement with the working element encased in the encasement wherein the encasement comprises a phase change material.

Yet another embodiment is provided in a method of forming a film capacitor. The method includes forming a working element comprising a dielectric and encasing the working element in an encasement wherein the encasement comprises a phase change material.

Yet another embodiment is provided in a film capacitor comprising: a working element comprising a dielectric; and an encasement with the working element encased in the encasement wherein the encasement comprises a polymeric phase change material or a solid-viscous-liquid phase change material.

Yet another embodiment is provided in a method of forming a film capacitor comprising:
forming a working element comprising a dielectric; and
encasing the working element in an encasement wherein the encasement comprises a
polymeric phase change material or a solid-viscous-liquid phase change material.

### BRIEF DESCRIPTION OF DRAWINGS

FIG. 1 is a cross-sectional schematic view of a working element of a film capacitor.

FIG. 2 is cross-sectional schematic view of an embodiment of the invention.

FIG. 3 is partial cut-away schematic view of an embodiment of the invention.

FIG. 4 is a graphical representation illustrating the advantages of the invention.

### DESCRIPTION

The present invention is related to an improved electronic component, and more specifically a film capacitor, particularly a polypropylene based film capacitor, wherein the electronic component is suitable for use in environments with the potential for high temperature excursions. More specifically, the present invention is related to an improved film capacitor comprising phase change materials wherein upon exposure to high temperature the phase change materials absorb the heat and undergo a phase transition thereby reducing the temperature the working element of the film capacitor will be exposed to.

Without being bound by theory, it is hypothesized that when the electronic component, such as a film capacitor, is subjected to heat the phase change material absorbs the heat. Heat excursions can occur as the result of circuit formation, such as through surface mounting technology (SMT) treatment, or during normal operation. The critical components are therefore shielded from heat associated with the circuitry by the phase change material and the heat is absorbed by the thermodynamics of the phase change of the phase change material.

A particular advantage of the instant invention is the ability to use low temperature high performance dielectrics in surface mount technology (SMT) assembly processes. The present invention allows the film capacitor to be used for SMT applications wherein soldering operation causes temperature excursions which may be above that which the dielectric can endure. The PCM absorbs the heat during the soldering assembly process insuring the dielectric does not endure the temperature excursion thereby protecting the dielectric against degradation.

Another advantage is provided in the ability to use dielectrics that are otherwise superior for electrical performance yet not suitable for the application due to their inability to withstand temperature excursions.

Another advantage of the invention is the ability to use film capacitors in SMT applications not previously considered suitable for such use. Similar problems occur with other electronic components. A number of families of capacitors are currently excluded form SMT applications due to the requirement that they be maintained at a low temperature to protect the dielectric of the working element. An example is polypropylene based electromagnetic interference (EMI) suppression capacitors which are currently only available in thru-hole technology. The polypropylene based capacitors cannot be soldered via reflow soldering due to degradation of the dielectric. The present invention provides film capacitors which can still be mounted using thru-hole technology, and they can resist much higher heat than conventional film capacitors, yet the film capacitors are now also suitable for use in SMT applications which was previously not suitable.

The invention will be described with reference to the figures which are an integral, but non-limiting, part of the specification provided for clarity of the invention. Throughout the various figures similar elements will be numbered accordingly.

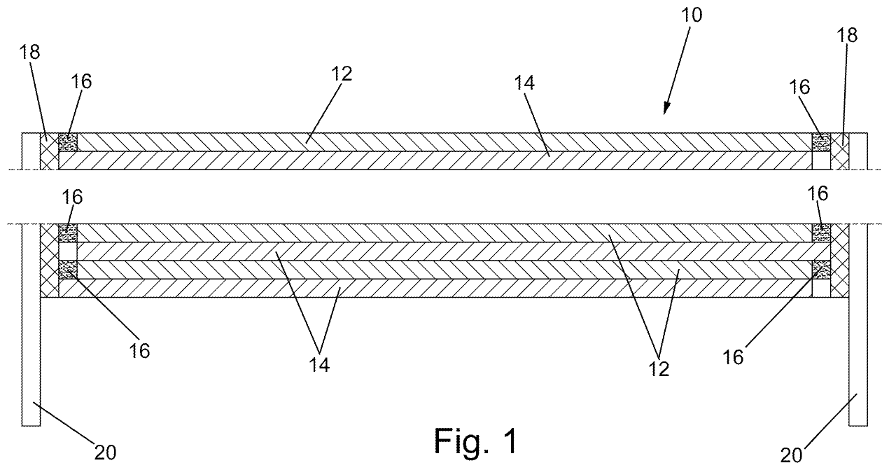

A working element of a film capacitor will be described with reference to FIG. 1 wherein a working element is illustrated in cross-sectional schematic view. In FIG. 1, the working element, 10, comprises metallized films, 14, with dielectric film, 12, between adjacent metallized films. Adjacent metallized films are in electrical contact with conductors, 18, of opposite polarity. The dielectric film optionally, but preferably, comprises end portions, 16, which are a manufacturing convenience to insure high conformity of the dielectric portion of the dielectric film between the end portions. Lead out terminals, 20, provide electrical contact to the conductors, 18. As would be realized to those of skill in the art each pair of adjacent metallized films, 14, terminating at opposite conductors, 18, with a dielectric there between forms a capacitive couple. The number of layers within the working element can be rather large or the working element can be wound thereby providing a continuous capacitive element due to the layered structure formed by the winding.

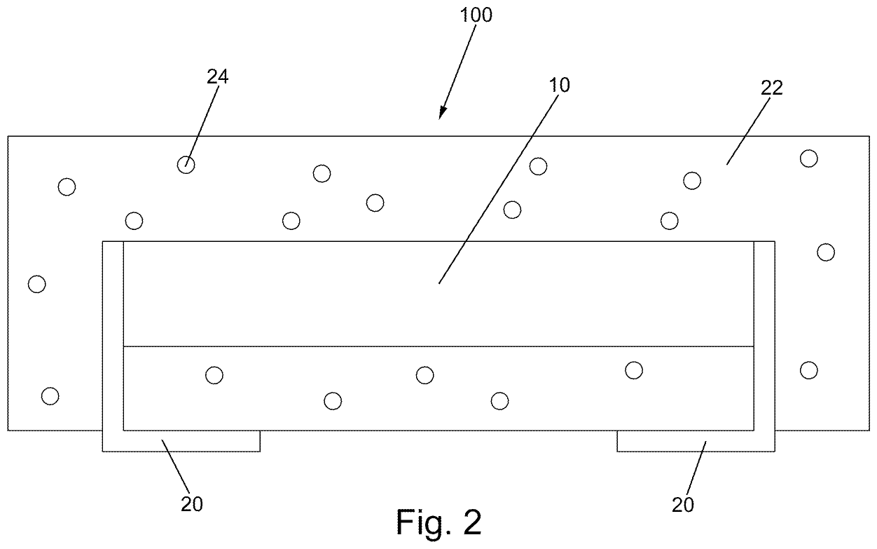

An embodiment of the invention will be described with reference to FIG. 2. In FIG. 2 an inventive capacitor, 100, is illustrated in cross-sectional schematic view. In FIG. 2, the working element, 10, with lead out terminals, 20, is in an encasement, 22, wherein the encasement comprises phase change material, 24, therein. As would be realized from the description herein, as the capacitor is subjected to thermal excursions the phase change material absorbs the heat and undergoes a phase transition thereby mitigating transfer of the thermal excursion to the working element.

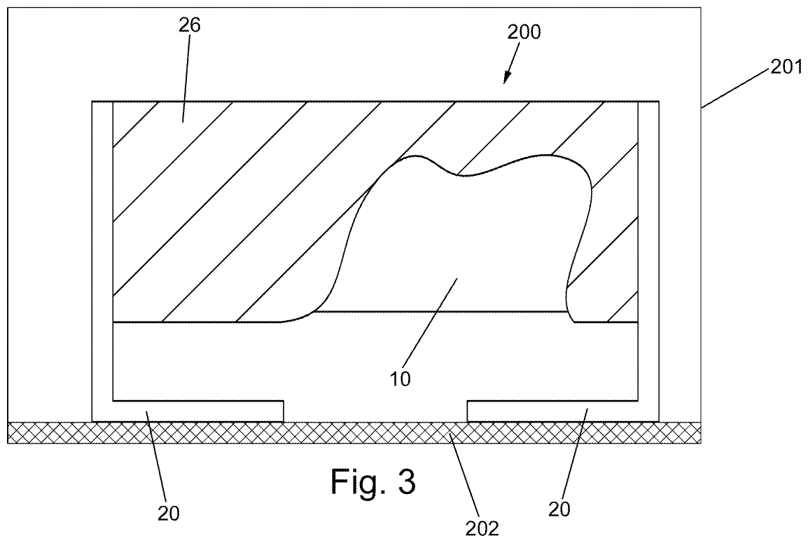

An embodiment of the invention will be described with reference to FIG. 3. In FIG. 3 an inventive capacitor, 200, is illustrated in partial cut-away schematic view within a device, 201. The working element, 10, with lead out terminals, 20, comprises a wrapping, 26, as the encasement wherein the wrapping comprises PCM or consist of PCM. The wrapping may comprise a substrate with PCM embedded therein either as discrete PCM regions within the substrate or as a layer or partial layer of the substrate.

The device, 201, comprises a substrate, 202, wherein the inventive capacitor is mounted to the substrate by SMT or through-hole techniques both of which are well known in the art. The device within which the inventive capacitor can be employed is not particularly limited herein. Particularly preferred devices wherein the inventive capacitor are particularly suitable include electronic devices for consumer applications or for use in the drive components or accessory components of vehicles. The inventive capacitors are also suitable for use in components associated with renewable energy segments such as a controller module or storage module of a solar panel or wind mill. Alternatively, devices within which the invention can be incorporated into include those capacitive elements particularly suitable for use as, or in, electromagnetic interference (EMI) suppressors, pulse capacitors, DC-link capacitors and AC filtering capacitors

Non-limiting examples of the phase change material may include alloys, organic phase change materials, water-based phase change materials, waxes, hydrated salt-based materials, solid-solid phase change materials, sugar alcohol based materials, solid-viscous-liquid phase change materials and polymeric phase change materials.

Particularly preferred phase change materials have an enthalpy for phase change in the range 0.1 kJ/kg to 4186 kJ/kg and more preferably 50 kJ/kg to 600 kJ/kg.

Particularly preferred phase change materials have has a phase change temperature of 45° C. to 300° C. and more preferably from 80° C. to 200° C.

Particularly preferred alloys for use as phase change materials include solders including InSn-based alloys, such as Indalloy 1E, which has a melting temperature of about 117° C.; InAg-based alloys, such as Indalloy 164, which has a melting temperature of about 154° C.; InPb-based alloys, such as Indalloy 204, which has a melting temperature of about 175° C.; and BiSn-based alloys, such as Indalloy 281, which has a melting temperatures of about 138° C.

Particularly preferred organic phase change materials include savE® HS89 from Pluss®, which has a melting temperature of about 89° C.; PureTemp® 151 from Pure Temp LLC, which has a melting temperature of about 151° C.; Paraffin 33-Carbon, which has a melting temperature of about 75.9° C.; PlusICE A118, which has a melting temperature of about 118° C.; and PlusICE A164, which has a melting temperature of about 164° C.

Water and water-based PCMs have a phase transition temperature of about 100° C.

Particularly preferred waxes include bees wax, carnauba wax and other paraffin waxes which are commercially available having melting points of about 50° C. to about 80° C.

Particularly preferred hydrated salt-based materials include PlusICE H120, which has a melting temperature of about 120° C.; magnesium chloride hexahydrate, which has a melting temperature of about 117° C.; and PlusICE S117 which has a melting temperature of about 117° C.

Particularly preferred solid-solid phase change materials include PlusICE X130, which has a phase transition temperature of about 130° C.; tris(hydroxymethyl)aminomethane which has a phase transition temperature of about 130° C.; and FSM-PCM95 from Forsman Scientific (Beijing) Co., Ltd., which has a phase transition temperature of about 134° C., a melting temperature of about 169° C. and an enthalpy energy of about 293 kJ/kg.

Particularly preferred solid-viscous-liquid phase change materials are based on rubber filler, such as 9005-H120 Series available from Guangdong Kingbali New Material Co. LTD, which has a phase transition temperature of about 120° C. and an enthalpy energy of about 200 kJ/kg.

Particularly preferred polymeric phase change materials are selected from the group consisting of polyethylene, high density polyethylene, low density polyethylene, linear low density polyethylene, polypropylene, polystyrene, acrylonitrile-butadiene-styrene and polycarbonate.

A solid-solid transition PCM is particularly preferred as it allows the component to withstand multiple reflow cycles or rework cycles without loss of thermal shield performance. A solid-liquid transition PCM is also particularly preferred provided the structure maintains the liquid within the structure and does not allow the liquid to spill out of the structure.

Liquid-vapor or solid-vapor transition phase change materials are suitable for use during heat absorption in the case of one time need such as during manufacturing.

Metallized films suitable for use in this invention are not particularly limited herein. In a particularly preferred embodiment the metallized films are formed as an evaporated metal coating on the surface of the dielectric film as well known to those of skill in the art. It is preferable that the metallized films comprise insulating margins on the side not being electrically connected to a conductor as known in the art. The metal is not particularly limited with aluminum and zinc being particularly suitable for demonstration of the invention.

The dielectric film is not particularly limited herein, however, plastic dielectric films are preferred. Particularly suitable films for use in demonstrating the invention include polypropylene (PP), polyethylene (PE), polyethylene terephthalate (PET), polyphenylene sulfide (PPS), tetrafluoroethylene (TFE), polystyrene (PS), polycarbonate (PC), cyclic olefin copolymer (COC), cyclo olefin polymer (COP) and combinations thereof. Fluorinated films, particularly fluorinated olefins, are particularly suitable with polyvinylidene fluoride (PVDF), and tetrafluoroethylene being exemplary. The dielectric film may comprise a composite oxide particle as a filler such as an oxide selected from the group consisting of barium titanium oxide, magnesium titanate, calcium titanate, strontium titanate and beryllium titanate. Other oxides suitable for demonstration of the invention include materials made of group 2 metallic elements from the second period to the fifth period in the periodic table specifically, barium titanium oxide, magnesium titanate, calcium titanate, and the like.

The conductors are not particularly limited herein. Conductors formed by metal deposition or from metal foils are particularly suitable for demonstration of the invention.

The lead out terminals are not particularly limited herein with any conventional lead out terminal commonly employed in the art being suitable for demonstration of the invention.

The encasement is not particularly limited herein with the proviso that the encasement is capable of containing a phase change material therein without significantly inhibiting the ability of the phase change material to undergo a phase change when exposed to temperature excursions. The encasement may include a resin either as a coating or within a box as is commonly employed in the art. The encasement may be coated, painted, sprayed, molded, cast or potted onto or around the working element. In a particularly preferred embodiment the encasement comprises at least 5 wt % phase change material, preferably at least 10 wt % phase change material, more preferably at least 20 wt % phase change material, more preferably at least 50 wt % phase change material, more preferably at least 80 wt % phase change material, and preferably up to 100 wt % phase change material.

During the formation of the working element metallized films and dielectric film are combined in a layered arrangement with adjacent metallized films arranged such that adjacent metallized layers can be subsequently electrically connected to connectors as would be realized to those of skill in the art. The layered arrangement is optionally and preferably rolled to form a winding.

### EXAMPLES

Sample capacitors were assembled with an internal wound capacitive element made of metallized polypropylene (PP) film with terminations formed from sprayed metal deposits (SMD) wherein the metal was aluminum or tin. The inventive capacitive element (PP+PCM) was wrapped in tris(hydroxymethyl)aminomethane as the phase change material. Posphorous bronze lead frames were used for electrical connection. The wrapped capacitive element was encapsulated by insertion in a glass fiber reinforced PPS box sealed with epoxy resin. The relative quantity of PCM used in this example was about 50 wt %.

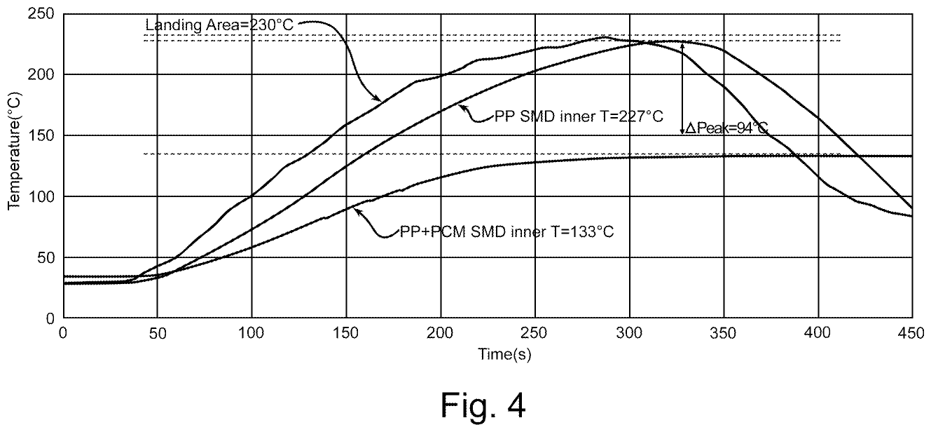

The critical temperatures of a typical reflow soldering process is represented graphically in FIG. 4. The landing area temperature curve is the temperature measured outside the element, but close to the element, which peaked at 230° C. The control exhibited an inner temperature of 227° C. which was only 3° C. below the landing area temperature. The inventive example demonstrated an inner temperature of 133° C. which is a 94° C. reduction in inner temperature relative to the control.

As would be realized from the results the capacitor assembled with the addition of PCM exhibits a much lower peak temperature compared to the control capacitor without PCM. The capacitor without PCM would not able to withstand the temperature of a reflow process

A series of otherwise identical film capacitors were assembled with the dielectric film listed in Table 1. An inventive sample, labeled PP+PCM, was prepared comprising tris(hydroxymethyl)aminomethane (50%) as the PCM. The attributes of each film capacitor are provided in Table 1.

TABLE 1

| | PP | PET | PEN | PPS | PP + PCM |
|---|---|---|---|---|---|
| SMT | no | mild | yes | yes | yes |
| DF | low | high | high | low | low |
| SH | good | mid | low | low | good |
| OT | 110 | 125 | 125 | 125 | 110 |

In Table 1, the film comprising a polypropylene dielectric with a phase change materialin the encasement, referred to as PP+PCM, was suitable for use at surface mount technology (SMT) reflow temperatures, the dissipation factor (DF) remained low, the self-healing (SH) capabilities remained and the operating temperature (OT in ° C.) was maintained.

The electrical performance during the reflow process was evaluated to demonstrate the invention. The samples and results are presented in Table 2. In Table 2, OC/C % is percentage capacitance deviation, Δtgδ(1 Khz) 10⁻⁴ is absolute dissipation factor deviation at 1 Khz, Δtgδ(10 Khz) 10⁻⁴ is absolute dissipation factor deviation at 10 Khz, ΔIR % is percentage insulation resistance deviation and ΔFBDV % is percentage first break-down voltage deviation.

TABLE 2

| | | Δtgδ(1 Khz) | Δtgδ(10 Khz) | | |
|---|---|---|---|---|---|
| Sample | ΔC/C % | 10⁻⁴ | 10⁻⁴ | ΔIR % | ΔFBDV % |
| PP | −77.3 | +30122.7 | +33146 | ≈−100 | ≈−100 |
| PP + PCM | −0.89 | +7.75 | +12 | ≈0 | −2 |

The results presented in Table demonstrate that the use of a phase change material can be beneficial which is contrary to the expectations of those of skill in the art. While those of skill in the art would expect detrimental results in electrical parameter deviation, such as insulation resistance deviation and the present invention demonstrates improvements.

U.S. Pat. No. 10,522,286 and U.S. Published Application No. 2003/0057265 are incorporated herein by reference.

The invention has been described with reference to preferred embodiments without limit thereto. One of skill in the art would realize additional embodiments which are described and set forth in the claims appended hereto.

1. A film capacitor comprising:
a working element comprising a dielectric; and
an encasement with said working element encased in said encasement wherein said encasement comprises a polymeric phase change material or a solid-viscous-liquid phase change material.

2. The film capacitor of claim 1 wherein said dielectric is a film dielectric comprising a material selected from the group consisting of polypropylene, polyester, polyethylene terephthalate, polyphenylene sulfide, tetrafluoroethylene, polystyrene, polycarbonate, fluorinated olefins, cyclic olefin copolymer, cyclo olefin polymer and combinations thereof.

3. The film capacitor of claim 2 wherein said dielectric comprises polypropylene.

4. The film capacitor of claim 1 wherein said polymeric phase change material is selected from the group consisting of polyethylene, high density polyethylene, low density polyethylene, linear low density polyethylene, polypropylene, polystyrene, acrylonitrile-butadiene-styrene and polycarbonate.

5. The film capacitor of claim 1 wherein said phase change material has an enthalpy for phase change range from 0.1 kJ/kg to 4186 kJ/kg.

6. The film capacitor of claim 5 wherein said phase change material has an enthalpy for phase change range from 50 kJ/kg to 600 kJ/kg.

7. The film capacitor of claim 1 wherein said phase change material has an phase change temperature of 45° C. to 300° C.

8. The film capacitor of claim 7 wherein said phase change material has an phase change temperature of 80° C. to 200° C.

9. The film capacitor of claim 1 wherein said encasement comprises at least 1 wt % said phase change material.

10. The film capacitor of claim 9 wherein said encasement comprises at least 5 wt % said phase change material.

11. The film capacitor of claim 10 wherein said encasement comprises at least 10 wt % said phase change material.

12. The film capacitor of claim 11 wherein said encasement comprises at least 20 wt % said phase change material.

13. The film capacitor of claim 12 wherein said encasement comprises at least 50 wt % said phase change material.

14. The film capacitor of claim 13 wherein said encasement comprises at least 80 wt % said phase change material.

15. The film capacitor of claim 1 wherein said encasement comprises up to 100 wt % said phase change material.

16. The film capacitor of claim 1 wherein said encasement is a wrapping.

17. The film capacitor of claim 1 wherein said encasement is coated, painted, sprayed, molded, cast or potted.

18. The film capacitor of claim 1 wherein said working element is a winding.

19. A device comprising a film capacitor of claim 1 mounted to a substrate.

20. The device of claim 19 wherein said device is selected from the group consisting of a vehicle, a control module or a storage module from the group consisting of a solar panel and wind mill system.

21. A device comprising a film capacitor of claim 1 wherein said film capacitor is an EMI suppressor, a pulse capacitor, a DC-Link capacitor or an AC filtering capacitor.

22. A method of forming a film capacitor comprising:
forming a working element comprising a dielectric; and
encasing said working element in an encasement wherein said encasement comprises a polymeric phase change material or a solid-viscous-liquid phase change material.

23. The method of forming a film capacitor of claim 22 further comprising winding said working element prior to said encasing.

24. The method of forming a film capacitor of claim 22 wherein said dielectric is a film dielectric comprising a material selected from the group consisting of polypropylene, polyester, polyethylene terephthalate, polyphenylene sulfide, tetrafluoroethylene, polystyrene, polycarbonate, fluorinated olefins, cyclic olefin copolymer, cyclo olefin polymer and combinations thereof.

25. The method of forming a film capacitor of claim 24 wherein said dielectric comprises polypropylene.

26. The method of forming a film capacitor of claim 22 wherein said polymeric phase change material is selected from the group consisting of polyethylene, high density polyethylene, low density polyethylene, linear low density polyethylene, polypropylene, polystyrene, acrylonitrile-butadiene-styrene and polycarbonate.

27. The method of forming a film capacitor of claim 22 wherein said phase change material has an enthalpy for phase change range from 0.1 kJ/kg to 4186 kJ/kg.

28. The method of forming a film capacitor of claim 27 wherein said phase change material has an enthalpy for phase change range from 50 kJ/kg to 600 kJ/kg.

29. The method of forming a film capacitor of claim 22 wherein said phase change material has an phase change temperature of 45° C. to 300° C.

30. The method of forming a film capacitor of claim 29 wherein said phase change material has an phase change temperature of 80° C. to 200° C.

31. The method of forming a film capacitor of claim 22 wherein said encasement comprises at least 1 wt % said phase change material.

32. The method of forming a film capacitor of claim 31 wherein said encasement comprises at least 5 wt % said phase change material.

33. The method of forming a film capacitor of claim 32 wherein said encasement comprises at least 10 wt % said phase change material.

34. The method of forming a film capacitor of claim 33 wherein said encasement comprises at least 20 wt % said phase change material.

35. The method of forming a film capacitor of claim 34 wherein said encasement comprises at least 50 wt % said phase change material.

36. The method of forming a film capacitor of claim 35 wherein said encasement comprises at least 80 wt % said phase change material.

37. The method of forming a film capacitor of claim 22 wherein said encasement comprises up to 100 wt % said phase change material.

38. The method of forming a film capacitor of claim 22 wherein said encasement is a wrapping.

39. The method of forming a film capacitor of claim 22 wherein said encasement is coated, painted, sprayed, molded, cast or potted.

40. A method for forming a device comprising mounting a film capacitor of claim 22 to a substrate of said device.

41. A method for forming a device comprising mounting a film capacitor formed by the method of claim 22 to a substrate.

42. The method for forming a device of claim 41 wherein said device is selected from the group consisting of a vehicle, a control module or a storage module from the group consisting of a solar panel or wind mill system.

43. A method for forming a device comprising mounting a film capacitor formed by the method of claim 22 further comprising incorporating said film capacitor into an EMI suppressor, a pulse capacitor, a DC-Link capacitor or an AC filtering capacitor.
